(19) United States
(12) Patent Application Publication
(10) Pub. No.: US 2018/0040218 A1
(43) Pub. Date: Feb. 8, 2018

(54) PULSED ELECTRONIC ARTICLE SURVEILLANCE DETECTION SYSTEM ABSENT OF A PHASING REQUIREMENT

(71) Applicants: Adam S. Bergman, Boca Raton, FL (US); Manuel Soto, Lake Worth, FL (US)

(72) Inventors: Adam S. Bergman, Boca Raton, FL (US); Manuel Soto, Lake Worth, FL (US)

(73) Assignee: Tyco Fire & Security GmbH, Neuhausen AM Rheinfall (CH)

(21) Appl. No.: 15/668,389

(22) Filed: Aug. 3, 2017

Related U.S. Application Data
(60) Provisional application No. 62/371,073, filed on Aug. 4, 2016.

(51) Int. Cl. G08B 13/24; G08B 29/18

(52) U.S. Cl. CPC G08B 13/2402; G08B 29/185

(57) ABSTRACT

Systems and methods for detecting a marker in a pulsed Electronic Article Surveillance (“EAS”) system. The methods comprise transmitting, from an EAS detection system, an excitation signal having a first frequency into an interrogation zone during a transmit phase of the EAS detection system. The excitation signal causes the marker to transmit a response signal having a second frequency different from the first frequency. The response signal is received at the EAS detection system during a receive phase of the EAS detection system.

### CROSS-REFERENCE TO RELATED APPLICATIONS

This patent application claims the benefit of U.S. Provisional Ser. No. 62/371,073 filed Aug. 4, 2016, which is incorporated in its entirety by reference herein.

### BACKGROUND

### Statement of the Technical Field

The present disclosure concerns generally to Electronic Article Surveillance (“EAS”) detection systems. More particularly, the present invention relates to EAS detection systems absent of a phasing requirement.

### Description of the Related Art

A typical EAS system in a retail setting may comprise a monitoring system and at least one marker (e.g., a security tag or label) attached to an article to be protected from unauthorized removal. The monitoring system establishes a surveillance zone in which the presence of markers can be detected. The surveillance zone is usually established at an access point for the controlled area (e.g., adjacent to a retail store entrance and/or exit). If an article is authorized for removal from the controlled area, then the marker thereof can be deactivated and/or detached therefrom. Consequently, the article can be carried through the surveillance zone without being detected by the monitoring system and/or without triggering the alarm. In contrast, if an article enters the surveillance zone with an active marker, then an alarm may be triggered to indicate possible unauthorized removal thereof from the controlled area.

In acoustomagnetic or magnetomechanical based EAS systems, the monitoring system excites the marker by transmitting an electromagnetic burst at a resonance frequency of the marker. When the marker is present within the electromagnetic field created by the transmission burst, the marker begins to resonate with an acoustomagnetic or magnetomechanical response frequency that is detectable by a receiver in the monitoring system. The monitoring system may then trigger the alarm.

Notably, the resonance frequency and response frequency are the same. The waveform of the monitoring system's transmitter and the intended receiver signal are the same as well. As a result, if a distant transmitter of a remote EAS system is not phased properly relative to the local EAS system, the remote EAS system could transmit a transmission burst during a receiver timeslot of the local EAS system. Accordingly, pulsed EAS systems are required to be phased together because the transmit and receive signals can be misinterpreted by the EAS systems if not timed properly. Phasing is a complex issue. If not done properly, EAS systems will be desensitized or possibly false alarm. Conventional solutions have been focused on auto phasing schemes, which have either tried to align transmitters or find “quiet” locations in time versus the environment.

### SUMMARY

The present invention concerns implementing systems and methods for detecting a marker in a pulsed EAS system (e.g., a magnetic based EAS detection system). The methods comprise transmitting, from an EAS detection system, an excitation signal having a first frequency into an interrogation zone during a transmit phase of the EAS detection system. The excitation signal causes the marker to transmit a response signal having a second frequency different from the first frequency. The response signal is received at the EAS detection system during a receive phase of the EAS detection system.

In some scenarios, the first frequency has a value that cannot be or is unable to be detected by a receiver of the second frequency. The second frequency can be less than or greater than the first frequency. The security tag may comprise a first coil, a second coil, a core on which the first and second coils are disposed, and a timing circuit electrically coupled to the first and second coils.

### BRIEF DESCRIPTION OF THE DRAWINGS

Embodiments will be described with reference to the following drawing figures, in which like numerals represent like items throughout the figures.

FIG. 1 is an illustration of an illustrative system.

FIGS. 2 and 3 provide illustrations of an illustrative EAS detection system.

FIG. 4 is an illustration of an illustrative system controller for an EAS detection system.

FIG. 5 is an illustration of an illustrative marker architecture.

FIG. 6 is an illustration of another illustrative marker architecture.

FIG. 7 is a flow diagram of an illustrative method for detecting a marker in an EAS system.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout the specification may, but do not necessarily, refer to the same embodiment.

Furthermore, the described features, advantages and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment”, “an embodiment”, or similar language means that a particular feature, structure, or characteristic described in connection with the indicated embodiment is included in at least one embodiment of the present invention. Thus, the phrases “in one embodiment”, “in an embodiment”, and similar language throughout this specification may, but do not necessarily, all refer to the same embodiment.

As used in this document, the singular form “a”, “an”, and “the” include plural references unless the context clearly dictates otherwise. Unless defined otherwise, all technical and scientific terms used herein have the same meanings as commonly understood by one of ordinary skill in the art. As used in this document, the term “comprising” means “including, but not limited to”.

The present solution relates to EAS systems absent of a phasing requirement. Since there is no longer a phasing requirement, the EAS systems are able to be setup without assistance. The EAS systems are designed so that at least one signal characteristic of the transmit and receive signals is the same. The signal characteristic includes, but is not limited to, a frequency. For example, in some scenarios, the resonance frequency F₁ and response frequency F₂ are different (i.e., F₁≠F₂). In effect, the marker (e.g., security tag or label) cannot be excited by a far field transmitter of another EAS system. As such, the remote transmitter in any position (time—relative to the zero crossing of an AC line) will not corrupt the marker's interrogation of the local EAS system. Therefore, false alarms are at least significantly reduced by the present solution.

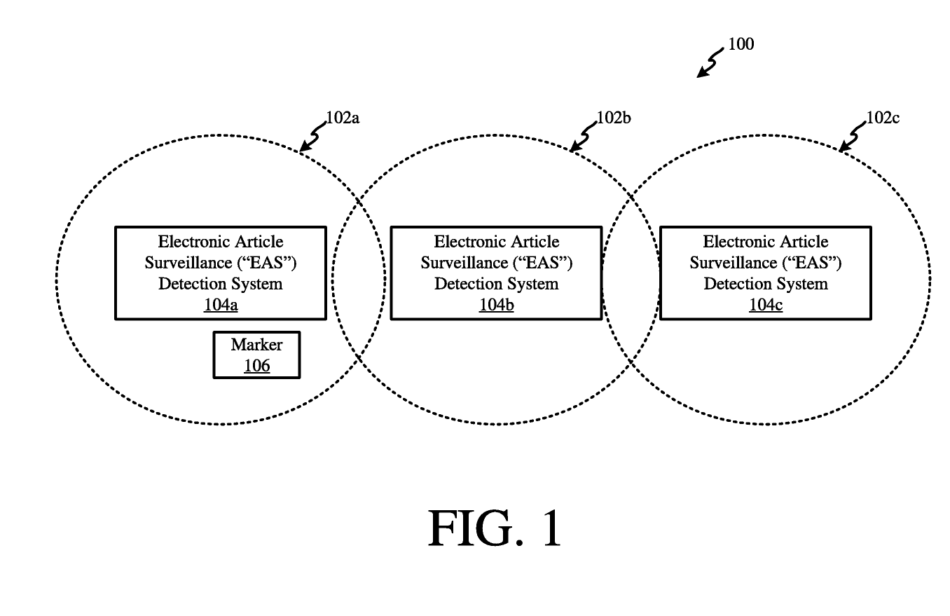

Referring now to FIG. 1, there is provided an illustration of an illustrative system 100. System 100 comprises a plurality of EAS detection systems 104a, 104b, 104c. Each of the EAS detection systems 104a, 104b, 104c is configured to monitor an area 102a, 102b, 102c (e.g., within a certain range of the EAS detection systems) as is known to detect EAS markers 106 having a predetermined characteristic (e.g., frequency). The coverage for each area 102a, 102b, 102c may overlap with adjacent areas. Further, the EAS detection systems 104a, 104b, 104c may be configured to communicate information therebetween using any suitable communications links (e.g., a wireless communications link).

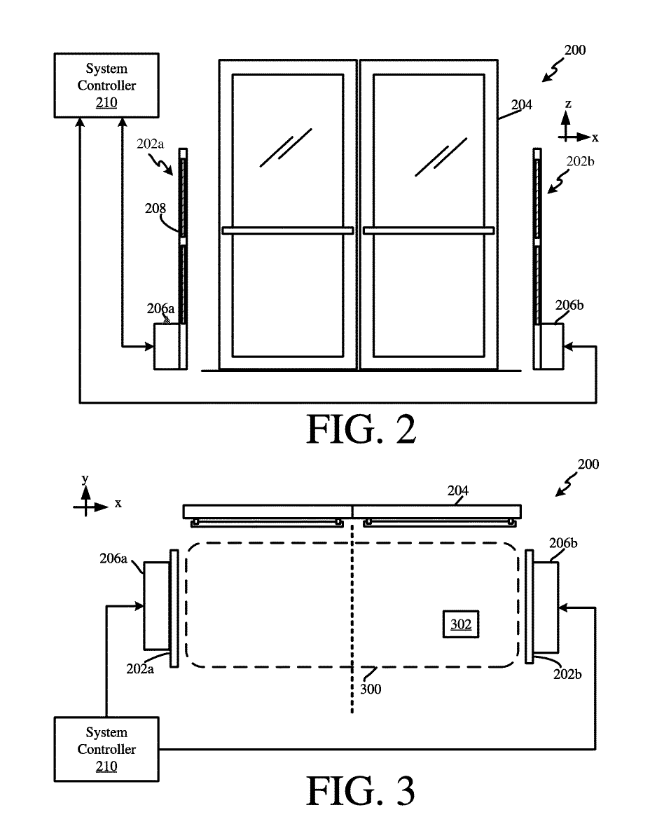

Referring now to FIGS. 2 and 3, there are provided illustrations of an illustrative EAS detection system 200. EAS detection system 104a, 104b, 104c of FIG. 1 is the same as or similar to EAS detection system 200 of FIG. 2. As such, the following discussion of EAS detection system 200 is sufficient for understanding EAS detection systems 104a, 104b, 104c of FIG. 1. EAS detection system 200 is described herein in terms of an AM EAS type detection system. However, the present solution can also be used in other types of EAS detection systems, including other types of magnetic based EAS detection systems.

The EAS detection system 200 will be positioned at a location adjacent to an entry/exit 204 of a secured facility (e.g., a retail store). The EAS detection system 200 uses specially designed EAS markers 302 which are applied to store merchandise or other items which are stored within a secured facility. The EAS markers 302 can be deactivated or removed by authorized personnel at the secure facility. For example, in a retail environment, the EAS markers 302 could be removed by a store employee (not shown). When an active EAS marker 302 is detected by the EAS detection system 200 in an idealized representation of an EAS detection zone 300 near the entry/exit, the EAS detection system 200 will detect the presence of such marker 302 and will sound an alarm or generate some other suitable EAS response, as described above. Accordingly, the EAS detection system 200 is arranged for detecting and preventing the unauthorized removal of articles or products from controlled areas.

The EAS detection system 200 includes a pair of pedestals 202a, 202b, which are located a known distance apart (e.g., at opposing sides of an entry/exit 204). The pedestals 202a, 202b are typically stabilized and supported by a base 206a, 206b. The pedestals 202a, 202b will each generally include one or more antennas 108 that are suitable for aiding in the detection of the special markers, as described herein. For example, pedestal 202a can include at least one antenna suitable for transmitting or producing an electromagnetic exciter signal field and receiving response signals generated by markers in the EAS detection zone 300. In some scenarios, the same antenna 208 can be used for both receive and transmit functions. Similarly, pedestal 202b can include at least one antenna 208 suitable for transmitting or producing an electromagnetic exciter signal field and receiving response signals generated by markers in the EAS detection zone 300. The antennas provided in pedestals 202a, 202b can be conventional conductive wire coil or loop designs as are commonly used in AM type EAS pedestals. These antennas will sometimes be referred to herein as exciter coils. In some scenarios, a single antenna can be used in each pedestal. The single antenna is selectively coupled to the EAS receiver. The EAS transmitter is operated in a time multiplexed manner. However, it can be advantageous to include two antennas (or exciter coils) in each pedestal as shown in FIG. 1, with an upper antenna positioned above a lower antenna.

The antennas 208 located in the pedestals 202a, 202b are electrically coupled to a system controller 210. The system controller 210 controls the operation of the EAS detection system 202 to perform EAS functions as described herein. The system controller 210 can be located within a base 206a, 206b of one of the pedestals 202a, 202b or can be located within a separate chassis at a location nearby to the pedestals. For example, the system controller 210 can be located in a ceiling just above or adjacent to the pedestals 202a, 202b.

As noted above, the EAS detection system comprises an AM type EAS detection system. As such, each antenna is used to generate an Electro-Magnetic (“EM”) field which serves as a marker exciter signal (or interrogation signal). The marker exciter signal causes a response signal to be generated by the marker within an EAS detection zone 300. In some scenarios, the marker comprises a plurality of resonators having different lengths which facilitate the reception of the marker exciter signal having a first frequency and the generation of a response signal having a second different frequency. In other scenarios, the marker comprises two coils with a common core (e.g., a ferrite core). The present solution is not limited to the marker architectures of these two scenarios. Other marker architectures can be used herein.

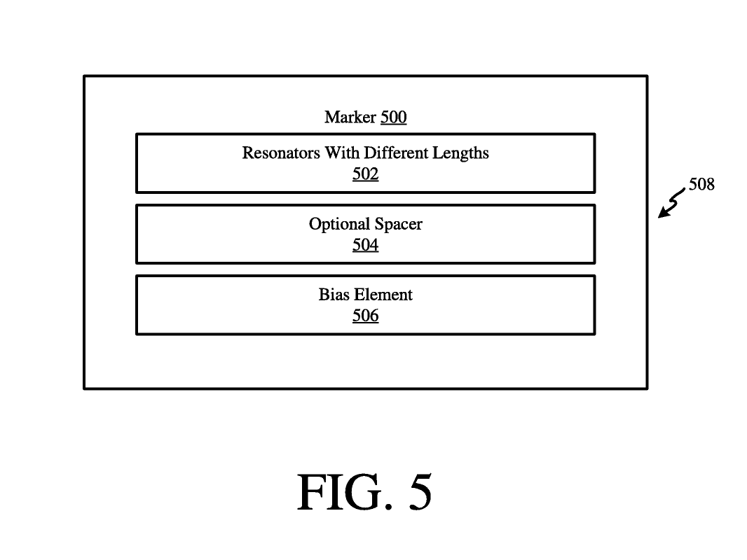

An illustration of an illustrative marker 500 is provided in FIG. 5. As shown in FIG. 5, the marker 500 comprises a plurality of resonators 502 with different lengths. The marker also comprises an optional spacer 504 and a bias element 506. Components 502-506 are well known in the art, and therefore will not be described herein.

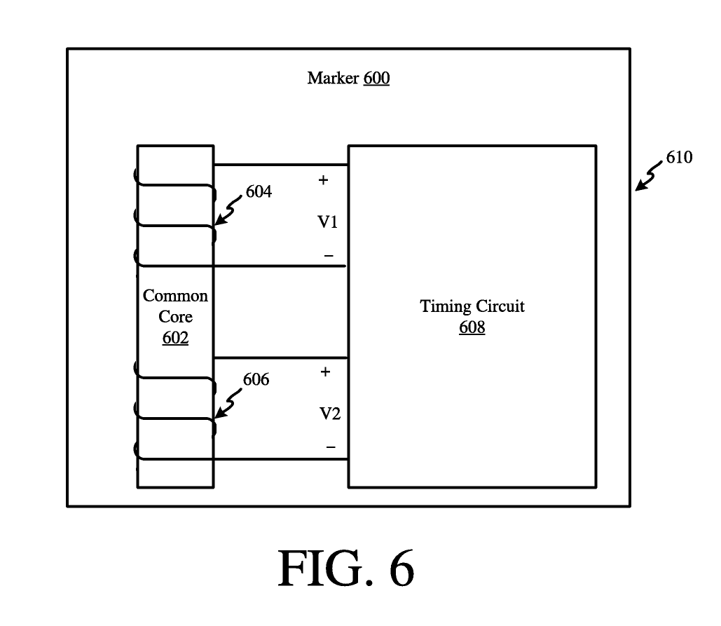

An illustration of an illustrative marker 600 with a common core 602 architecture is shown in FIG. 6. During operation, the marker exciter signal causes a first voltage V1 to be generated by a first coil 604 contained in the marker's housing 610. The first voltage V1 is supplied to a timing circuit 608 also contained in the marker's housing 610. Some or all components of the timing circuit 608 can be implemented as hardware, software and/or a combination of hardware and software. The hardware includes, but is not limited to, one or more electronic circuits. The electronic circuits can include, but are not limited to, passive components (e.g., resistors and capacitors) and/or active components (e.g., amplifiers and/or microprocessors). The passive and/or active components can be adapted to, arranged to and/or programmed to perform one or more of the methodologies, procedures, or functions described herein. Upon the expiration of a pre-defined amount of time, the timing circuit 608 supplies a second voltage V2 to a second coil 606. The second voltage V2 can be the same as or different than the first voltage V1. In turn, the second coil 606 emits a response signal therefrom. The response signal has a frequency that is different than the frequency of the marker exciter signal.

The response signal transmission will continue for a brief time after the stimulus signal is terminated. The response signal is received at the receiver antenna. The received response signal is used to indicate a presence of the marker within the EAS detection zone. As noted above, the same antenna contained in a pedestal 202a, 202b can serve as both the transmit antenna and the receive antenna. Accordingly, the antennas in each of the pedestals 202a, 202b can be used in several different modes to detect a marker exciter signal.

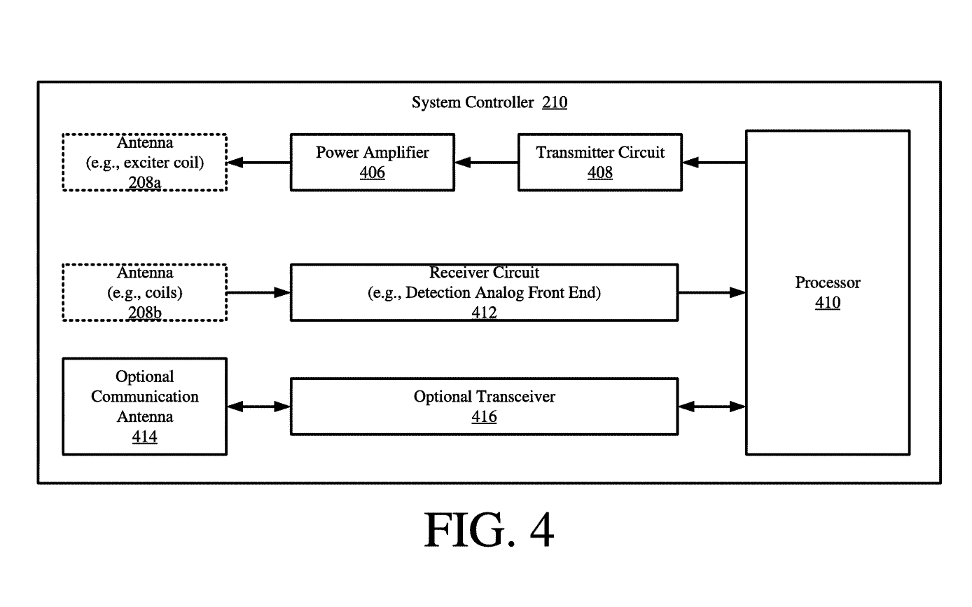

Referring now to FIG. 4, there is provided an illustration of illustrative architecture for the system controller 210 of FIG. 2. The system controller 210 comprises a power amplifier 406, a transmitter circuit 408, a receiver circuit 412, and a processor 410. Each of the listed components are well known in the art, and therefore will not be described in detail herein.

As shown in FIG. 4, the transmitter circuit 408 is coupled to a first antenna 208a, and the receiver circuit 412 is coupled to a second antenna 208b. The first antenna 208a may be disposed in a first pedestal 202a of a pair of pedestals, and the second antenna 208b for the receiver circuit 412 may be disposed in a second pedestal 202b of the pair of pedestals. The present solution is not limited in this regard. For example, both antennas 208a and 208b can be contained in the same pedestal, and/or collectively comprise a single antenna.

The listed components 406-412 together define a marker monitoring control portion that controls the transmission from and reception of signals at an antenna 208a, 208b. The marker monitoring control portion can be provided in any known manner to control the transmissions and receptions at the interrogation antenna 402 to monitor for EAS markers 302 within an interrogation zone 300. The system controller 210 also includes an optional communication antenna 414 and an optional transceiver 416 to provide communications between different controllers in one or more EAS detection systems.

The operations of the marker monitoring control portion will now be described in more detail. The transmitter circuit 408 is coupled to the first antenna 208a via the power amplifier 406. The first antenna 208a emits transmit (e.g., “Radio Frequency (“RF”)) bursts at a predetermined frequency (e.g., 58 KHz) and a repetition rate (e.g., 50 Hz, 60 Hz, 75 Hz or 90 Hz), with a pause between successive bursts. In some scenarios, each transmit burst has a duration of about 1.6 ms. The transmitter circuit 408 is controlled to emit the aforementioned transmit bursts by the processor 410, which also controls the receiver circuit 412. The receiver circuit 412 is coupled to the second antenna 208b. The second antenna 208b comprises close-coupled pick up coils of N turns (e.g., 100 turns), where N is any number.

When the EAS marker 302 resides between the antennas 208a, 208b as shown in FIG. 3, the transmit bursts transmitted from the transmitter circuit 408 cause a response signal to be generated by the EAS marker 302. Notably, the frequency F₂ of the response signal is different than the frequency F₁ of the transmit bursts, i.e., F₁≠F₂. The frequencies F₁ and F₂ have values selected so that cross-talk will not occur and/or so that interference does not occur between the two signals. In this regard, the frequency F₁ has to be such that it cannot be or is unable to be seen by the receiver of frequency F₂. This will be dictated by the typical bandwidth of the receiver. For example, in some scenarios, a difference between the values of the frequencies F₁ and F₂ is at least 3-5 KHz. The second frequency F₂ can be greater than or less than the first frequency F₁. Thus, if the first frequency F₁ is 58 KHz, then the second frequency F₂ is 53 KHz or 63 KHz. The present solution is not limited to the particulars of this example.

The processor 410 controls activation and deactivation of the receiver circuit 412. When the receiver circuit 412 is activated, it detects signals at the predetermined frequency (e.g., 53 KHz or 63 KHz) within first and second detection windows. In the case that a transmit burst has a duration of about 1.6 ms, the first detection window will have a duration of about 1.7 ms which begins at approximately 0.4 ms after the end of the transmit burst. During the first detection window, the receiver circuit 412 integrates any signal at the predetermined frequency which is present. In order to produce an integration result in the first detection window which can be readily compared with the integrated signal from the second detection window, the signal emitted by the EAS marker 302 should have a relatively high amplitude (e.g., greater than or equal to about 1.5 nanowebers (nWb)).

After signal detection in the first detection window, the processor 410 deactivates the receiver circuit 412, and then re-activates the receiver circuit 412 during the second detection window which begins at approximately 6 ms after the end of the aforementioned transmit burst. During the second detection window, the receiver circuit 412 again looks for a signal having a suitable amplitude at the predetermined frequency (e.g., 53 kHz or 63 KHz). Since it is known that a signal emanating from the EAS marker 302 will have a decaying amplitude, the receiver circuit 412 compares the amplitude of any signal detected at the predetermined frequency during the second detection window with the amplitude of the signal detected during the first detection window. If the amplitude differential is consistent with that of an exponentially decaying signal, it is assumed that the signal did, in fact, emanate from an EAS marker 302 between antennas 208a, 208b. In this case, the receiver circuit 412 issues an alarm.

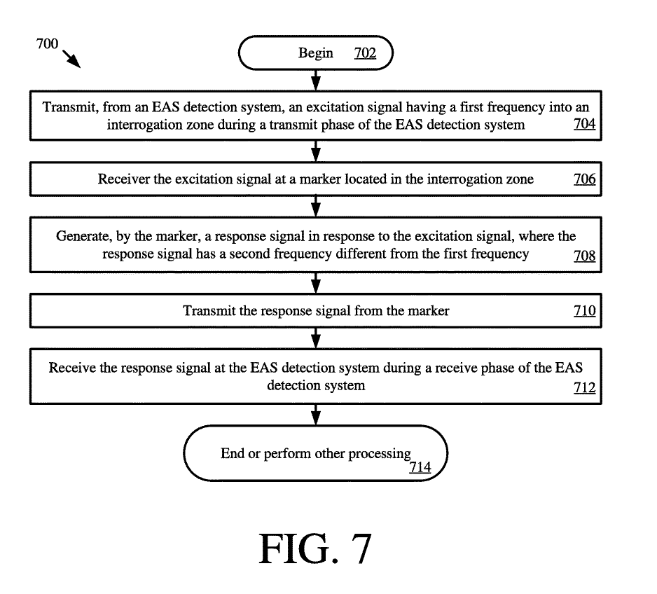

Referring now to FIG. 7, there is provided a flow diagram of an illustrative method 700 for detecting a marker (e.g., marker 500 of FIG. 5 or marker 600 of FIG. 6) in an EAS system (e.g., system 100 of FIG. 1). Method 700 begins with 702 and continues with 704 where an excitation signal is transmitted from an EAS detection system (e.g., EAS detection system 104a-104c of FIG. 1 or EAS detection system 200 of FIG. 2) into an interrogation zone (e.g., interrogation zone 300 of FIG. 3) during a transmit phase of the EAS detection system. The excitation signal has a first frequency F1. The excitation signal is then received by the marker located in the interrogation zone, as shown by 706. In response to the excitation signal, the marker generates a response signal in 708. The response signal has a second frequency F2 different from the first frequency F1. The second frequency can be less than or greater than the first frequency. Next in 710, the response signal is transmitted from the marker. The response signal is received at the EAS detection system during a receive phase of the EAS detection system, as shown by 712. Subsequently, 714 is performed where method 700 ends or other processing is performed (e.g., return to 704).

Although the invention has been illustrated and described with respect to one or more implementations, equivalent alterations and modifications will occur to others skilled in the art upon the reading and understanding of this specification and the annexed drawings. In addition, while a particular feature of the invention may have been disclosed with respect to only one of several implementations, such feature may be combined with one or more other features of the other implementations as may be desired and advantageous for any given or particular application. Thus, the breadth and scope of the present invention should not be limited by any of the above described embodiments. Rather, the scope of the invention should be defined in accordance with the following claims and their equivalents.

What is claimed is:

1. A method for detecting a marker in a pulsed Electronic Article Surveillance (“EAS”) system, comprising:
transmitting, from an EAS detection system, an excitation signal having a first frequency into an interrogation zone during a transmit phase of the EAS detection system, the excitation signal causing the marker to transmit a response signal having a second frequency different from the first frequency; and
receiving the response signal at the EAS detection system during a receive phase of the EAS detection system.

2. The method according to claim 1, wherein the first frequency has a value that is unable to be detected by a receiver of the EA second frequency.

3. The method according to claim 1, wherein the second frequency is less than the first frequency.

4. The method according to claim 1, wherein the second frequency is greater than the first frequency.

5. The method according to claim 1, wherein the EAS detection system comprises a magnetic based EAS detection system.

6. The method according to claim 1, wherein the marker comprises a first coil, a second coil, a core on which the first and second coils are disposed, and a timing circuit electrically coupled to the first and second coils.

7. A method for operating an Electronic Article Surveillance (“EAS”) system, comprising:
transmitting, from an EAS detection system, an excitation signal having a first frequency into an interrogation zone during a transmit phase of the EAS detection system;
receiving the excitation signal at a marker located within the interrogation zone;
generating, by the marker, a response signal in response to the excitation signal, the response signal having a second frequency different from the first frequency;
transmitting the response signal from the marker; and
receiving the response signal at the EAS detection system during a receive phase of the EAS detection system.

8. The method according to claim 7, wherein the first frequency has a value that is unable to be detected by a receiver of the second frequency.

9. The method according to claim 7, wherein the second frequency is less than the first frequency.

10. The method according to claim 7, wherein the second frequency is greater than the first frequency.

11. The method according to claim 7, wherein the EAS detection system comprises a magnetic based EAS detection system.

12. The method according to claim 7, wherein the marker comprises a first coil, a second coil, a core on which the first and second coils are disposed, and a timing circuit electrically coupled to the first and second coils.

13. A pulsed Electronic Article Surveillance (“EAS”) system, comprising:
a marker; and
an EAS detection system comprising a circuit configured to
transmit an excitation signal having a first frequency into an interrogation zone during a transmit phase of the EAS detection system, the excitation signal causing the marker to transmit a response signal having a second frequency different from the first frequency, and
receive the response signal during a receive phase of the EAS detection system.

14. The pulsed EAS system according to claim 1, wherein the first frequency has a value that is unable to be detected by the second frequency.

15. The pulsed EAS system according to claim 1, wherein the second frequency is less than the first frequency.

16. The pulsed EAS system according to claim 1, wherein the second frequency is greater than the first frequency.

17. The pulsed EAS system according to claim 1, wherein the EAS detection system comprises a magnetic based EAS detection system.

18. The pulsed EAS system according to claim 1, wherein the marker comprises a first coil, a second coil, a core on which the first and second coils are disposed, and a timing circuit electrically coupled to the first and second coils.
